(19) United States
(12) Patent Application Publication
(10) Pub. No.: US 2014/0372217 A1
(43) Pub. Date: Dec. 18, 2014

(54) OPTIMAL ZOOM INDICATORS FOR MAP SEARCH RESULTS

(71) Applicant: International Business Machines Corporation, Armonk, NY (US)

(72) Inventors: Lisa Seacat DeLuca, Baltimore, MD (US); Lydia M. Do, Raleigh, NC (US); Charles M. Kinard, Cary, NC (US)

(73) Assignee: International Business Machines Corporation, Armonk, NY (US)

(21) Appl. No.: 13/917,009

(22) Filed: Jun. 13, 2013

(51) Int. Cl. G06F 17/30; G06Q 30/02; G06F 3/0484

(52) U.S. Cl. CPC G06F 17/30554; G06F 3/0484; G06Q 30/0256
USPC 705/14.54; 715/767

(57) ABSTRACT

A system, method and computer program product for indicating an optimal magnification level for displaying search query results in a mapping application running in a computer device. The method comprises: obtaining search results for a business or category of interest in a geographical area; determining the search results to be displayed within a mapping application; determining an optimal magnification level corresponding to a search result; generating a magnification indicator for indicating an optimal magnification level for the search result to be displayed within the mapping application; and adjusting the display within the mapping application to change to the determined optimal magnification level responsive to selecting the magnification indicator for that search result.

### FIELD OF INVENTION

The present disclosure generally relates to map search programs, systems and structures, and more particularly, to a novel optical zoom indicator for enabling optimal viewing via an interface of map program search and query results.

### BACKGROUND

Interactive mapping applications (Google® Maps, Mapquest® YAHOO Maps, Microsoft live maps, Bing Maps) are well known in the art. These on-line service “mapping” applications and downloadable software “mapping” applications allow users to see an overview road map or satellite image of an area, get directions from one point to the next, or display the geographic position of search results. Currently, systems such as Google® Maps allow a user to search for a business, points of interest, geographic locations, and have results visually displayed on a user's browser device. FIG. 1 depicts a conventional Google® Maps application generated output, generated for presentation on a computer system display 10, indicating results 172 returned as a text list 15, e.g., including results of businesses displayed in a first textual results portion 25, and a set of map display objects or markers 20, each marker showing a specific location corresponding to a displayed text results on a map display portion 35. The example depicted in FIG. 1 shows example search results 17 for coffee establishments, e.g., resulting from an example user search for coffee beverage in San Francisco. The displayed map objects, e.g., flags or indicators 20 correspond to search results 17 of interest while the text panel 25 correlates the map markers 20 to the corresponding results, e.g. a corresponding business name/profile. The map displayed in map display portion 25 may be presented as a road map, a topological map, or some combination thereof.

The current mind set is to use a map as a way to see a larger area for route purposes. However, secondary in purpose when a user is interested in just an area (e.g., shopping region, city, etc.) they may not be looking for routing purposes but rather to see what businesses and landmarks are in that vicinity.

U.S. Pat. No. 7,995,079 entitled Automatic Map Zoom-level Adaptation a technique for establishing a zoom-level for mobile devices responsive to a user's request for directions or a map of an area. Map parameters can be taken into account along with the speed of the user as that user travels a route in order to adjust the zoom-level.

There remains a need for specifying to a user, via a text/map results display an optimal viewing level for viewing the particular display result.

### BRIEF SUMMARY

A system, method and computer program product for determining and providing to a viewer an optimal Zoom-level indicator that recommends to users a zoom level that a viewer should be at for enabling optimal viewing of information on the map.

More particularly, for interactive maps where a user may perform a search, when the search results are returned, the system and methods of the disclosure enhances the display of textual data (i.e. list of search results) as well as Map Data (i.e., Zoom-Scale) so that the user will have indication as to which Zoom-level best fits the search results (i.e., an optimal Zoom-level).

According to one aspect, there is provided a system, method and computer program product for a mapping application running in a computer device. The method comprises: obtaining search results for a business or category of interest in a geographical area; determining the search results to be displayed within a mapping application; determining an optimal magnification level corresponding to a search result; generating a magnification indicator for indicating an optimal magnification level for the search result to be displayed within the mapping application; and adjusting the display within the mapping application to change to the determined optimal magnification level responsive to selecting the magnification indicator for that search result.

According to a further aspect, there is provided a system for indicating an optimal magnification level when displaying search query results in a mapping application. The system comprises: a memory storage device; a computing device in communication with the memory storage device and configured to perform a method to: obtain search results for a business or category of interest in a geographical area; determine the search results to be displayed within a mapping application; determine an optimal magnification level corresponding to a search result; generate a magnification indicator for indicating an optimal magnification level for the search result to be displayed within the mapping application; and adjust the display within the mapping application to change to the determined optimal magnification level responsive to selecting the magnification indicator for that search result.

In a further aspect, a computer program product is provided for performing operations. The computer program product includes a storage medium readable by a processing circuit and storing instructions run by the processing circuit for running a method. The method is the same as listed above.

### BRIEF DESCRIPTION OF THE SEVERAL VIEWS OF THE DRAWINGS

The objects, features and advantages of the present invention will become apparent to one of ordinary skill in the art, in view of the following detailed description taken in combination with the attached drawings, in which:

FIG. 1 depicts a conventional Google® Maps application generated output, generated for presentation on a computer system and display, indicating results 10;

FIGS. 2A-2C shown an example implementation depicting results of operations of the system and method to generate a magnification indicator for indicating an optimal magnification level for the search results in one or both text result and map result portions of the mapping application display area;

FIG. 3 generally depicts a further embodiment in which the search results returned as graphical data annotate the displayed interactive zoom level magnification setting tool;

FIG. 4 shows one method 100 for providing optimal zoom-level indications for a mapping application in one embodiment; and

FIG. 5 illustrates an exemplary hardware configuration of a computing system infrastructure 200 in which the present methods are run.

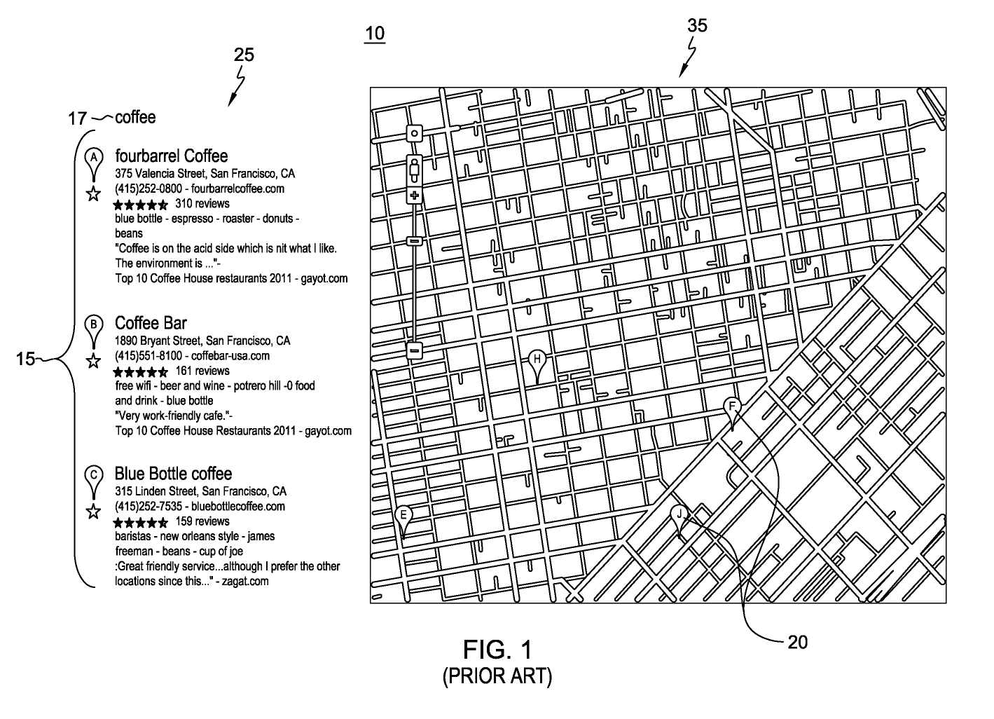

### DETAILED DESCRIPTION

The system, method and computer program product establishes a zoom level based on search results of a mapping application providing a text/map display portion(s).

In one example implementation, the system, method and computer program product establishes in a mapping application, a zoom level based on search results such as a relevant business of interest.

The system and computer program product implements methods, in conjunction with an operating mapping application, for establishing, determining and providing to a viewer an optimal Zoom-level indicator that recommends to a user (or viewer) a zoom level that the viewer should be at for enabling optimal viewing of a search result information on a map. As referred to herein, a mapping application zoom level, zoom level setting or zoom level indicator is used interchangeably with respective magnification level, magnification level setting and magnification level indicator.

More particularly, in conjunction with interactive mapping applications such as Google Maps, Mapquest, etc. in a computer device or mobile computing device, methods are implemented for establishing a zoom level based on the search result, e.g., a business, or place of interest, or some other criteria.

The methods of the particular mapping application that provides interactive maps on user devices, and returns for display search results responsive to a user search, are provided with additional routines for annotating the displayed search result with an indication as to which zoom-level best fits the search results (e.g., optimal Zoom-level). In one embodiment, the input to determining the optimal zoom level is the search results, including the geolocation for each item in the results. For a first search result, the map is centered on the geolocation for that first result, and the zoom level is just large enough to show enough navigational context. For example, the zoom level is not so close to show only the building and not see the streets upon which to approach the building, but not so far to lose the navigational detail because of too many streets or too small size of streets rendered on the screen. For the rest of the items in the search results, the optimal zoom level should be both (1) large enough to show both this item and the first item or preceding items on the map at the same time, and (2) just large enough to show enough navigational context for the included items.

Thus, the methods include enhancing both Textual data (i.e. list of search results) as well as Map Data (i.e., zoom-scale) to show the optimal zoom-level for businesses/landmarks in the search results.

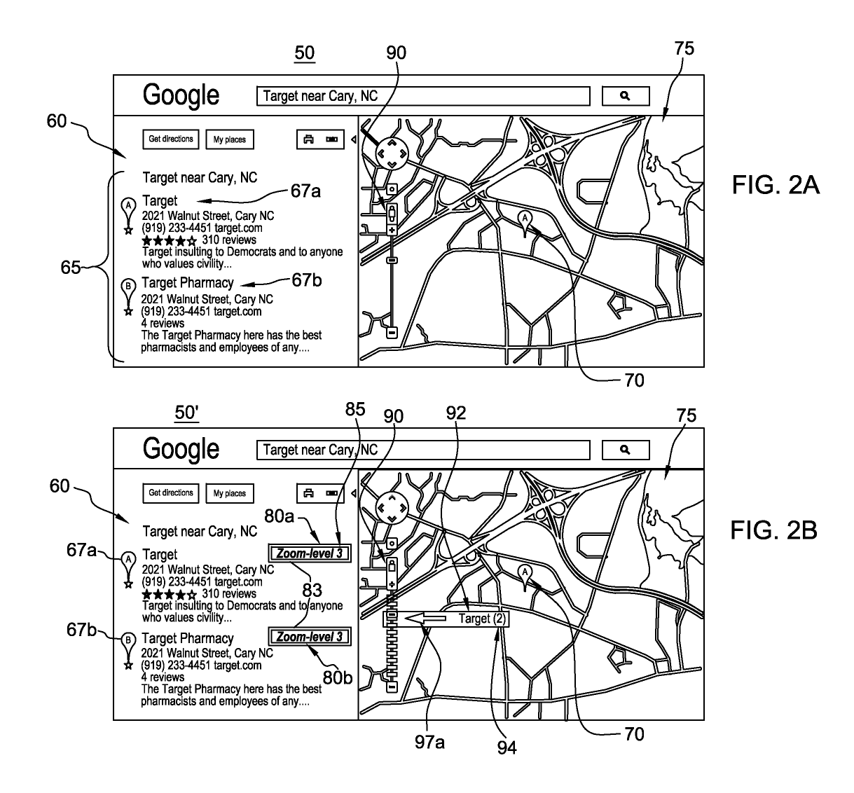

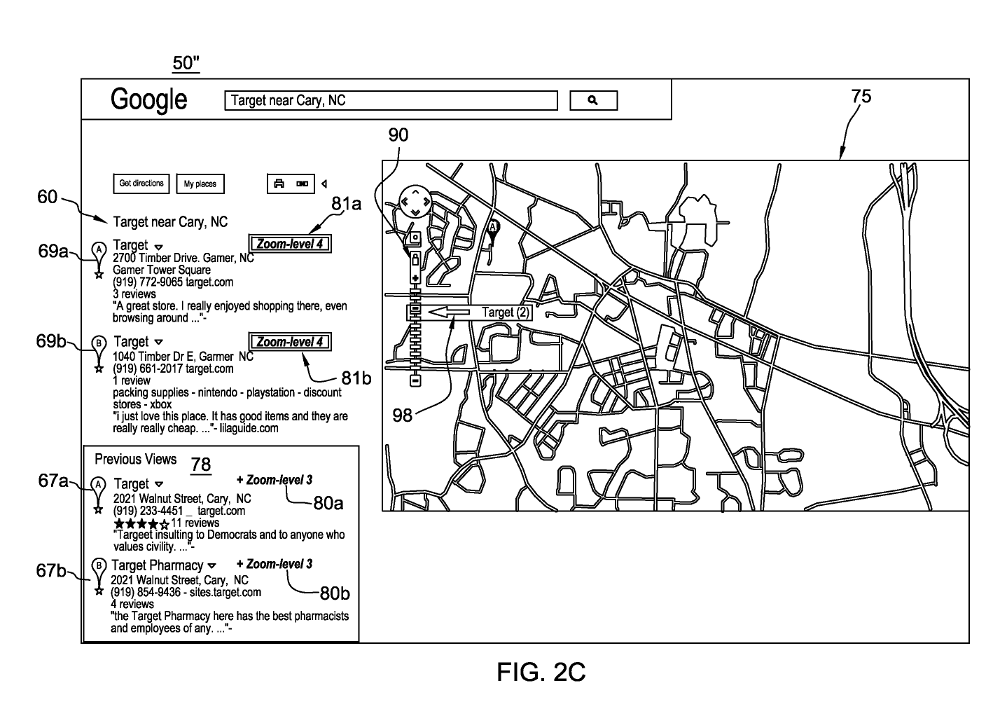

FIGS. 2A-2B shown an example implementation depicting operations of the methods described herein. FIG. 2A shows a conventional Google Maps mapping application user search results display 50 having a text display portion 60 displaying a list 65 of text results, and a map display portion 75. For illustrative purposes only, a user has entered via the mapping application (e.g., Google Maps) a specific retailer business “Target” in a particular geographic area. As further shown, the mapping application of FIG. 2A provides, via conventional means, an interactive zoom level magnification setting tool 90 (e.g. alternately referred to as a “zoom bar”) for enabling users (viewers) of magnification to be set either by a user or by program control, to optimally view the displayed map and any corresponding search results in the map display portion 75. These displayed search results take many forms depending upon the particular mapping application employed and the particular device or user interface.

FIG. 2B illustrates an example user search results display 50′ displaying results of the methods used to generate and annotate the example search results text display 50 of FIG. 2A. In the embodiment depicted, applicable for any particular mapping application, the methods herein generate and annotate each corresponding search result 67a, 67b in the search results text display portion 60 and map display portion 75 of FIG. 2A with a corresponding optimal zoom-level indicator. FIG. 2B shows respective optimal zoom-level indicators 80a, 80b or like annotation for recommending the optimal zoom-level for a particular corresponding search result 67a, 67b displayed in search results text list 65 displayed in display portion 60. In a non-limiting embodiment, the generated optimal zoom-level indicators 80a, 80b are annotated on the search results display portion as boxes 83 with the recommended zoom-level 85 indicated and in one embodiment, are visually or color contrasted, to permit easier viewing. As shown, the optimal zoom-level indicators 80a, 80b are located next to the corresponding text results, e.g., indicates a zoom-level corresponding to a searched for business establishment “Target” in a location “Cary, N.C.” is best seen at Zoom-Level “3”. It is understood that the optimal zoom-level indicator (or marker, flag or other graphical display “object”) may take on any graphic style, shape or form to annotate the conventional results display of FIG. 2B.

As further shown in FIG. 2B, the mapping application is caused to set the provided zoom level setting tool or “zoom bar” 90 at the corresponding determined optimal zoom level in the map display portion 75 for the selected search result. The zoom level setting tool 90 is further shown in FIG. 2B as being further annotated with the determined optimal zoom-level indicator 97a corresponding to a selected corresponding to search result 67a, for example. In one embodiment, the determined optimal zoom-level indicator 97a is generated to display or annotate the zoom bar 90 with an indicator showing the name of the business (or corresponding search result) shown at 92, and total number of hits at that zoom-level shown at 94 (e.g., two (2) total “Target” businesses found in the area shown at optimal Zoom-Level “3”. In one embodiment, the magnification zoom level setting tool 90 may automatically default to the determined optimal zoom-level setting as indicated, e.g., a zoom level “3”.

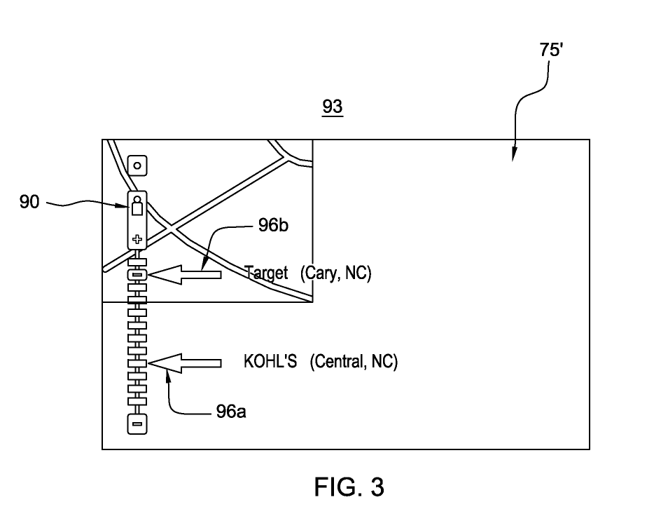

Alternatively, the mapping application displayed in FIGS. 2B, 2C and 3 may display the mapping portion search result at a default optimal zoom level determined for the top user search result, for example, or, default to a pre-determined zoom-level.

Referring back to FIG. 2B, it is understood that the user may interactive with the new zoom bar element 90 and its annotated optimal zoom-level indicator. Thus, a user may interact with the map (via functionality provided by the mapping application employed, e.g., Google Maps) and may zoom in by selecting a “−” zoom setting on zoom-bar 90, for example, to decrease a zoom level magnification. The updated text results are updated as depicted in FIG. 2C as display 50″, for example, to show further search results determined optimal at the new zoom-bar magnification level setting. For example, by a user changing the zoom level in the manner as depicted in map display portion, further new search results 69a, 69b are now shown with their corresponding optimal zoom-level indicators (annotations) 81a, 82a indicating the user-selected zoom-level. For example, in FIG. 2C, the example search result for the business “Target” is at different location as optimally indicated at (a user-selected) Zoom-Level “4” as shown by the indicator 98 in a square and indicating contrasted colored text for ease in viewing in map display portion 75.

In one embodiment, as shown in FIG. 2C, the mapping application is further enhanced with methods such that a previous search results may be presented for display as shown under a “Previous views” section 78 of the text search results display portion 60 displaying a user's prior search results 67a, 67b. If the user clicks on “+ Zoom-Level 3”, e.g., by clicking or selecting a prior result annotated optimal zoom-level indicator 80a or 80b, then the text display portion 60 and map display portion 75 will again be further updated to the previous displayed results view as shown in FIG. 2B.

FIG. 3 generally depicts a further embodiment in which the search results returned as graphical data on the displayed interactive map portion 75′ enhance the zoom level setting tool 90 with multiple (e.g., two or more) optimal zoom-level indicators, which are further annotated with correlating textual information from the displayed search result. In the example search results display 93 of FIG. 3, according to a further embodiment, the methods and processes described herein, in response to a more general user search for a general retailer (for example, rather than for a search for a specific retailer (e.g., “Target”)), cause the mapping application to display different user query search results, e.g., retail stores, each at their optimal zoom-levels. In one example embodiment, there are multiple logical horizontal slots up and down the level setting tool that one may scroll to and or select to set a zoom or magnification level of a map display portion. The logical slots map to a zoom level on the level setting tool immediately in the corresponding map display portion 75′, similar to a label. Starting at the top of the ranked search results, the optimal zoom level is determined as described herein above (e.g., using the #1 ranked search result as the base). Stepping down the ranked search results, the optimal zoom level is determined for each ranked search result. Then that ranked search result is placed in the slot for the corresponding zoom level. If the slot is already full, then the current occupant(s) stay in the slot, unless other criteria such as advertising revenue will cause a current occupant to be replaced or shared. For the text boxes 81a, 81b, etc. shown in FIG. 2C, the optimal zoom level 85 determined is simply listed in the text boxes. Those text boxes can also be controls, such as when they are clicked then the map is driven to the zoom level as indicated in the text box, without having to interact with the zoom level setting tool directly. For example, in this further embodiment, as shown in FIG. 3, the method for annotating the magnification zoom level setting tool 90 further implements routines for annotating the zoom level setting tool 90 in an example map display portion 75′ with a first optimal magnification level indicator 96a corresponding to the optimal zoom level of a first search result displayed in said text portion, and a second optimal magnification level indicator 96b corresponding to a further search result displayed in the text portion. As shown, the displayed optimal zoom level indicators 96a, 96b correspond to search results determined to be optimally viewed at respective different zoom level settings. For example, users may be automatically provided with display indicator 96a at a determined optimal zoom-bar level “2”, for example, which corresponds to a searched business and location result “Target” shown in a city (e.g., Cary. NC), and simultaneously be provided with a further displayed indicator 96b, e.g., an indicator at determined optimal Zoom-level “9”, for example, corresponding to a searched business and location result “Kohl's” shown in a city (e.g., Central. NC), on the displayed map as a result of the more generic user search.

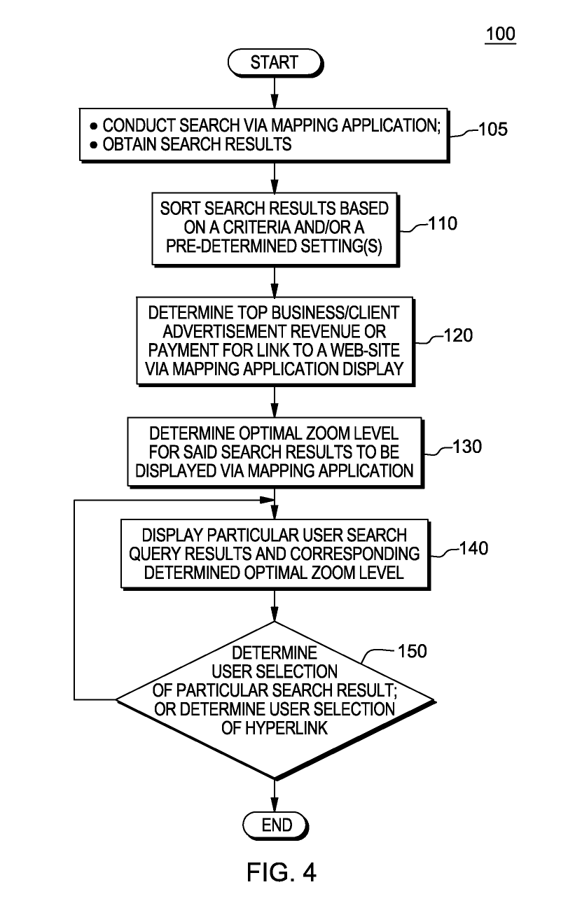

FIG. 4 shows, in one embodiment, a method 100 for indicating an optimal magnification level for displayed interactive map search query display results of a mapping application running in a computer device as shown in the example of FIG. 2B. Particularly, software objects, software routines, processes, and other devices operating under control of a programmed computing device implement: at 105, obtaining search result(s) information in response to a user query/search request as performed by the mapping application in conjunction with a mapping application search engine. For example, the request may include a location of an address, a geographical area, a desired business or point of interest in a geographical area as in conventional mapping applications. Then, at 110, according to one aspect, when obtaining user query mapping application search results, the method includes automatically performing sorting the results. The sorting can be performed based on any number of internal or external criteria/data, including, but not be limited to: the user's current location, a business loyalty programs that the user is a member of, coupons in the user's passbook, 3rd-party reviews/ratings, traffic congestion, social media, previous searches, etc. For example, in one embodiment, step 110 may include first determining which results from the mapping application are the top search results to be displayed. In one embodiment, the mapping application returns its own ranking of the search results. However, at step 110, there is provided an opportunity to modify the ranking based on criteria, a pre-determined setting(s), or a combination of a criteria and setting, as programmed in the mapping application, and before being shared/displayed to the user.

For example, in one embodiment, the determining of one or more search results to be displayed with optimal zoom-level indicator may be based on particular business. For example, the method may implement an algorithm for determining an amount of advertising revenue received from one or more business entities desirous of having search hit results for that business displayed by said mapping application. The method then performs selecting one or more search results to be displayed based on said advertising revenue received.

More particularly, in FIG. 4, at 110 and 120, the search results may be sorted and presented for display at 130 based on a criteria, or a pre-determined setting. The criteria may include, but not limited to: revenues received from a particular business/es, or be based on a name of a top business (e.g., based top search result hit). It may be based on top search results/hits at particular Zoom-levels. The sort may be based on a total number of hits of prior search result for similar queries at one or more Zoom-levels of display. Additionally, what is further shown is that the annotation generated may be graphically and/or textually enhanced to display search result information, e.g., a City/State/Zip location, at the optimal Zoom-level indicator, or other relevant search results.

As a further example, as shown at 120 as an optional and non-limiting step, the method may first determine top businesses\clients who provide the most advertisement revenue, or payment for link to a web-site via mapping application display who have display priority via the mapping application results display. Then, continuing at 130, the method includes determining an optimal magnification level corresponding to each of the one or more searched and/or sorted search results to be displayed. Thus, if an example search result ranked at #5 pays more advertising revenue than search result #3, then the display priority may be changed in that search result #5 is displayed in a more prominent way that search result #3 (i.e., larger font or different color that draws more attention, or if they complete for the same slot next to the level setting tool then #5 is displayed and #3 is not), or the ranked order is changed so that the original search result #5 is displayed in the list before original search result #3 (i.e., #5 is in the 3^{rd} position, and #3 is in the 4^{th} position).

It should be understood that, in the examples presented, the steps may be carried out in the order recited, or the steps may be carried out in another order.

In one embodiment, the results sorting/display setting with optimal zoom-level indicator(s) may be user-configured and programmable via a mapping application interface either prior to or after obtaining search results. The actual display of particular user search query results with optimal zoom level indicator, as shown in example output results of FIGS. 2B, 2C and 3, is then generated for the obtained search results at 140, FIG. 4.

Additionally, the mapping application is further caused to respond to a user query and generate the annotation with further graphical and/or textual search results in addition to the optimal zoom level. For example, in a non-limiting way, the annotation may display, and or cause for display upon user selection of a particular optimal zoom level: text names of points of interest, landmarks, and other locations in the vicinity of a search result. There may be further generated for display with the annotation a corresponding number of hits for results at a particular magnification level.

In a further embodiment, the generated optimal magnification level indicators 80a, 80b associated with a search result displayed in mapping application text display portion such as shown in FIGS. 2A-2C and FIG. 3, may be user selectable links or hyperlinks. Thus, from a user's search results returned as textual data in text display portion 60, e.g., as displayed next to the search results text, an optimal Zoom-level 80a is shown. In response to user selecting this magnification level indicator 80a, embodied as a link, the search results map portion 75 is automatically configured to display a corresponding optimal zoom level annotation at the determined optimal magnification level. For the search results returned as graphical data on the displayed interactive map portion 75 in FIG. 2B, the zoom-bar 90 is enhanced to show correlating textual information from the search results or a hyperlink to further results (not shown) in FIGS. 2B, 2C.

In one embodiment, in response to user selecting a magnification level indicator link associated with a search result displayed, the search results map portion is configured to display a corresponding optimal zoom level annotation at the determined optimal magnification level. Further, as shown in FIG. 4 at 150, as a user interacts with the different search results or returned links, the optimal zoom-level for each of those items may cause the magnification setting of the interactive map to change. Thus, for example, at 150, via underlying processes, the mapping application performs detecting a user selection(s) of particular search result(s) and/or corresponding selection of a hyperlink, and in response to such detecting, the process returns to step 140 to display the particular user search query results and corresponding determined optimal zoom level. Thus, for example, in the mapping application, after obtaining the search results and either prior to or after generating and annotating the search results display portions with search result(s), the decision step 150 may first be implemented to determine whether a user has selected a particular search result via the interactive interface, e.g., such as selecting from the text list displayed in search result display portion 60 of FIG. 2B. For example, the user selection of annotated optimal zoom level link 80a, in text display portion 60 of FIG. 2B, invokes generation and display of a corresponding zoom-level indicator 97a and the setting of corresponding determined optimal zoom level at interactive map portion 75 of FIG. 2B.

In a further embodiment, depending upon agreements and/or policies, the particular mapping application may be configured to further display with the generated optimal magnification level indicator an advertisement or a link(s) to a web-site or application providing an advertisement associated with a product/service of a business. The generated magnification level indicator in the search results map portion is configured to display may further display or provide a hyper link(s) to a web-site providing a coupon(s) associated with goods or services available at the business or further information pertaining to the business.

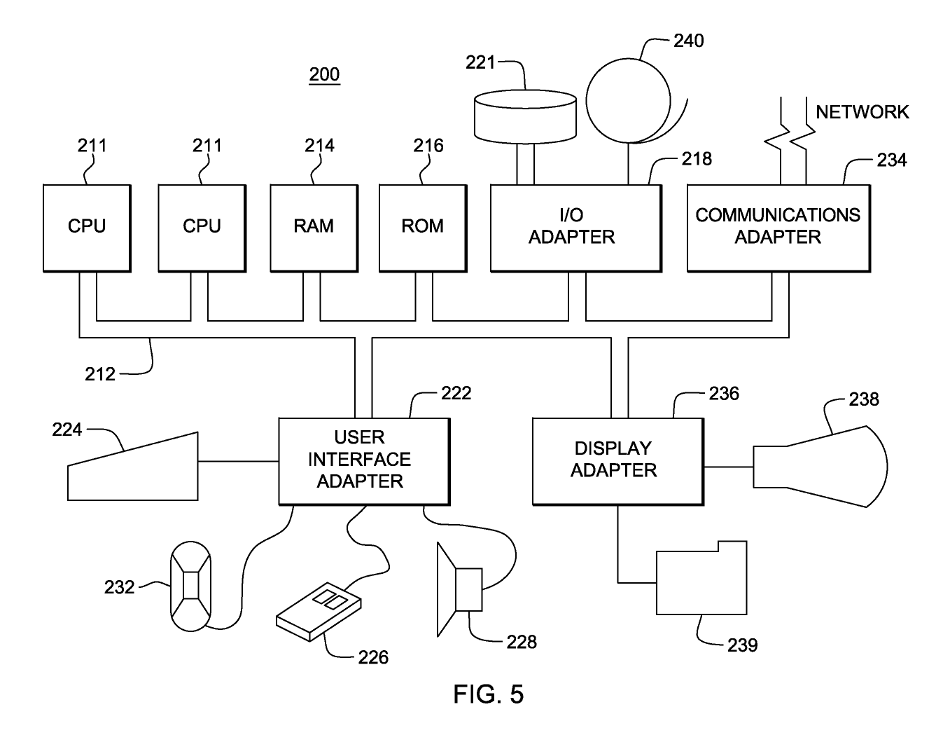

FIG. 5 illustrates an exemplary hardware configuration of a computing or mobile device computing system infrastructure 200 in which the present methods are run. In one aspect, computing system 200 receives the search results from a user input search query in a mapping application, and is programmed to perform the method processing steps of FIG. 4. The hardware configuration preferably has at least one processor or central processing unit (CPU) 211. The CPUs 211 are interconnected via a system bus 212 to a random access memory (RAM) 214, read-only memory (ROM) 216, input/output (I/O) adapter 218 (for connecting peripheral devices such as disk units 221 and tape drives 240 to the bus 212), user interface adapter 222 (for connecting a keyboard 224, mouse 226, speaker 228, disk drive device 232, and/or other user interface device to the bus 212), a communication adapter 234 for connecting the system 200 to a data processing network, the Internet, an Intranet, a local area network (LAN), etc., and a display adapter 236 for connecting the bus 212 to a display device 238 and/or printer 239 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more tangible computer readable medium(s) having computer readable program code embodied thereon.

Any combination of one or more computer readable medium(s) may be utilized. The tangible computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing. The computer readable medium excludes only a propagating signal.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for a mapping application running on a computer device comprising:
obtaining search results for a business or category of interest in a geographical area;
determining the search results to be displayed within a mapping application;
determining an optimal magnification level corresponding to a search result;
generating a magnification indicator for indicating an optimal magnification level for the search result to be displayed within the mapping application; and
adjusting the display within the mapping application to change to the determined optimal magnification level responsive to selecting the magnification indicator for that search result.

2. The method of claim 1, wherein the mapping application provides a display area for search results that includes: a text portion configured to display textual data, a map portion configured to display mapping data, or both text portion and map portion.

3. The method of claim 1, wherein the generated magnification indicator comprises one of:
a user selectable link of the optimal magnification level; and
a label describing a zoom level value for the optimal magnification level.

4. The method of claim 2, further comprising: annotating the display of a mapping application with a generated magnification level indicator for each search result in a text portion, map portion, or both text portion and map portion.

5. The method of claim 4, wherein said annotating said display of said mapping application in said map portion with a generated magnification level indicator includes annotating an interactive magnification tool configured for selecting a zoom level of magnification for search results displayed on said map portion.

6. The method of claim 5, wherein said annotating said interactive magnification tool comprises:
annotating said interactive magnification tool with a first optimal magnification level indicator corresponding to a first search result displayed in said text search results portion, and a second optimal magnification level indicator corresponding to a further search result displayed in said text results portion, wherein said first optimal indicator and second optimal indicator are displayed at respective different zoom level settings.

7. The method of claim 1, wherein a generated magnification level indicator indicates one or more of: a text name of a business or location of interest searched, a corresponding location, a corresponding number of hits for results at that magnification level, a link to an advertisement associated with a business, or a link to a coupon associated with goods or services available at said business.

8. The method of claim 1, wherein said determining said search results to be displayed includes:
determining an amount of advertising revenue received from one or more business entities desirous of having search hit results for that business displayed by said mapping application; and
selecting said one or more search results to be displayed based on said advertising revenue received.

9. The method of claim 5, wherein responsive to a selection of a magnification level via said displayed interactive magnification tool, said method comprises:
generating a magnification level indicator for indicating said selected magnification level;
annotating one or more textual search results at said displayed search results text portion with its corresponding generated magnification level indicator; and
populating said displayed search results map portion with objects corresponding to search results optimally viewed via said display at said user selected a magnification level.

10. The method of claim 1, further comprising:
generating for display, a previous search results list view indicating prior textual search results data displayed in association with a prior selected optimal magnification level.

11.-23. (canceled)
